(19) United States
(12) Patent Application Publication
(10) Pub. No.: US 2007/0243354 A1
(43) Pub. Date: Oct. 18, 2007

(54) Image-recording medium with thermally insulating layer

(75) Inventors: Susan E. Bailey, Corvallis, OR (US); Andrew L. Van Brocklin, Corvallis, OR (US); Vladek P. Kasperchik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/406,189

(22) Filed: Apr. 18, 2006

(51) Int. Cl. B32B 3/02

(52) U.S. Cl. 428/64.6; 369/288

(57) ABSTRACT

An image-recording medium includes a substrate, one or more writable layers adapted to be written by laser radiation characterized by a laser wavelength to form an image therein, and one or more thermally insulating layers comprising a material substantially transparent both at the laser wavelength and at wavelengths in the visible spectrum.

### CROSS-REFERENCE TO RELATED APPLICATION

This application is related to co-pending and commonly assigned applications, Ser. No. 10/351,188, filed Jan. 24, 2003; Ser. No. 10/695,718, filed Oct. 28, 2003; and Ser. No. 10/864,016, filed Jun. 9, 2004, the entire disclosure of each of which is incorporated herein by reference.

### TECHNICAL FIELD

This invention relates generally to image recording media and methods.

### BACKGROUND

Optical recording technology that enables consumers and others to record laser-written labels on specially coated recordable CD and DVD media has enjoyed notable commercial success. To enable the label recording, a surface of the medium is coated with a writable layer of a material that changes appearance when it absorbs laser light of a predetermined wavelength.

If a writable layer is exposed to high power laser radiation, e.g., heating with the imaging laser to temperatures above several hundred ° C., there may be ablation of the writable layer material. Products of ablation may contaminate imaging optics and thus may result in system performance degradation. In some circumstances (multilayered imageable coatings, for example), heat generated in a writable layer by the laser radiation may be conducted to an adjacent layer of the medium. Heat transfer from a layer currently being imaged to an adjacent layer may result in thermal cross-talk (color development in the layer adjacent to the imaged layer). In a case of multi-layered laser-imageable coatings, heat diffusion from a currently imaged layer into adjacent layers may result in significant heat losses and thus may degrade marking speed and efficiency. Also, low molecular weight species, for example, may also diffuse between adjacent layers and cause chemical compatibility issues. Improper handling can subject an exposed writable layer to contaminating substances such as plasticizers. Thus, there is a need for further improved media adapted for label marking.

### BRIEF DESCRIPTION OF THE DRAWINGS

The features and advantages of the disclosure will readily be appreciated by persons skilled in the art from the following detailed description when read in conjunction with the drawings, wherein:

FIG. 1A is a cutaway perspective view of a disk medium, with cross-sectional detail 1B, illustrating a first embodiment of an image-recording medium.

FIG. 1B is a magnified cross-sectional detail of FIG. 1A.

FIG. 2 is a cross-sectional elevation view of a prior-art embodiment of an image-recording medium.

FIG. 3 is a cross-sectional elevation view of a second embodiment of an image-recording medium.

FIG. 4 is a cross-sectional elevation view of a third embodiment of an image-recording medium.

FIGS. 5 and 6 are molecular diagrams associated with various embodiments of a thermally insulating layer embodiment.

FIG. 7 is a flowchart illustrating embodiments of methods for fabricating media embodiments.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting.

Throughout this specification and the appended claims, the phrase “image recording medium” includes, but is not limited to, optical storage discs.

One aspect of the embodiments disclosed provides an image-recording medium 10, including a substrate 20, one or more writable layers 30 adapted to be written by laser radiation 40 characterized by a laser wavelength λ_{L} to form an image therein, and one or more thermally insulating layers 50 comprising a material substantially transparent both at the laser wavelength λ_{L} and at wavelengths λ_{V} in the visible spectrum.

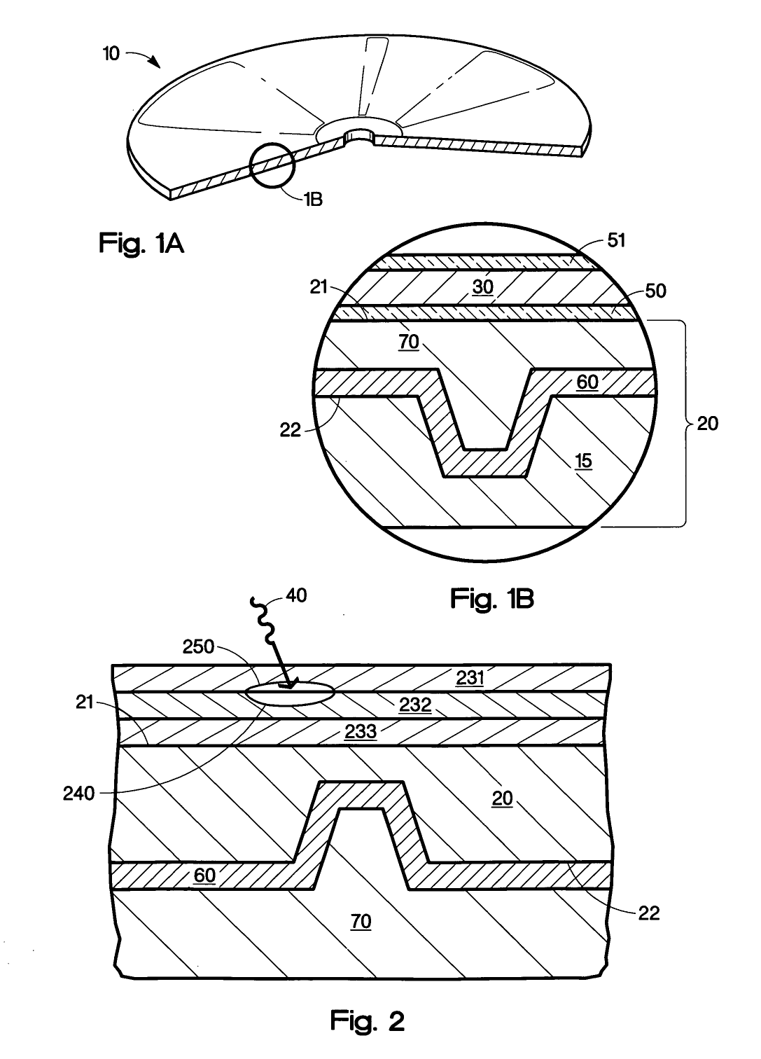

FIG. 1A is a cutaway perspective view of a disk medium, with magnified cross-sectional details in FIG. 1B, illustrating a first embodiment of an image-recording medium 10. As shown in FIGS. 1A and 1B, substrate 20 may have the form of a compact disk (CD), a digital versatile disk (DVD), an HD-DVD, a Blu-ray Disc™ (BD), a holographic versatile disk (HVD), or a video disk, for example. Such disks are commonly formed of a molded polycarbonate material. (HD-DVD's and Blu-ray Discs™ are high-definition versions included in the term DVD in this specification). HD-DVD format specifications are available from the DVD Forum of Tokyo, Japan or online from http://www.dvdforum.org/forum.shtml. Blu-ray Disc™ format specifications are available from the Blu-ray Disc License Entity, Sony Corporation, of Tokyo, Japan or online from http://www.blu-raydisc.info/). For many common applications, the two generally planar sides of disk substrate 20 are different from each other, with the writable layers for labeling and the associated thermally insulating layers disposed adjacent to a first side 21 of the substrate, and with the second side 22 of the disk substrate being adapted for recording of information on it.

The embodiment shown in FIGS. 1A and 1B has data recorded on its bottom side, as illustrated by a single data pit stamped into top surface 22 of substrate disk 15, which may be formed of polycarbonate. A combined reflective layer and data layer 60, intended for one-time recording, is made from a thin film of aluminum above a thin film of data-recording material. As shown in FIG. 1B, the data has already been recorded. Layer 60 constitutes a recording layer, the aluminum film enhancing reflection of the light used for reading the data. A protective layer 70 covers and protects the recording layer. Substrate disk 15 may be approximately 600 micrometers thick for DVD media and 1200 micrometers thick for CD media. For DVD media, the material of substrate disk 15 may be polycarbonate approximately 600 micrometers thick, for example. For CD media, protective layer 70 may be acrylic lacquer approximately 2-4 micrometers thick. On the disk's top side 21, a thermally insulating layer 50 underlies writable layer 30. Insulating layer 50 minimizes heat conduction away from writable layer 30. Another thermally insulating layer 51 (optional) may cover and protect the writable layer 30. The entire combination of disk 15, reflective data layer 60, and protective layer 70 serves as substrate 20 for the combination of thermally insulating layer 50, writable layer 30, and optionally thermally insulating layer 51.

FIG. 2 shows a cross-sectional elevation view of a prior-art embodiment of an image-recording medium, illustrating a problem solved by the embodiments disclosed herein. Three laser-writable layers 231, 232, and 233 on top surface 21 of substrate 20 are adapted to be written in three different colors. Laser radiation 40 is shown schematically in FIG. 2, impinging on writable layer 232 on which it is intended to write an image. The material of writable layer 232 is heated above the ambient temperature locally by the laser radiation to change the color. An isotherm 240 represents a particular temperature in layer 232, sufficient to change the color in layer 232. However, heat may be conducted into adjacent writable layer 231 as well, represented by isotherm 250, sufficient to unintentionally change the color in writable layer 231. This is an example of interlayer crosstalk, an undesirable effect that can degrade the quality of images written to label some image-recording media of the prior art.

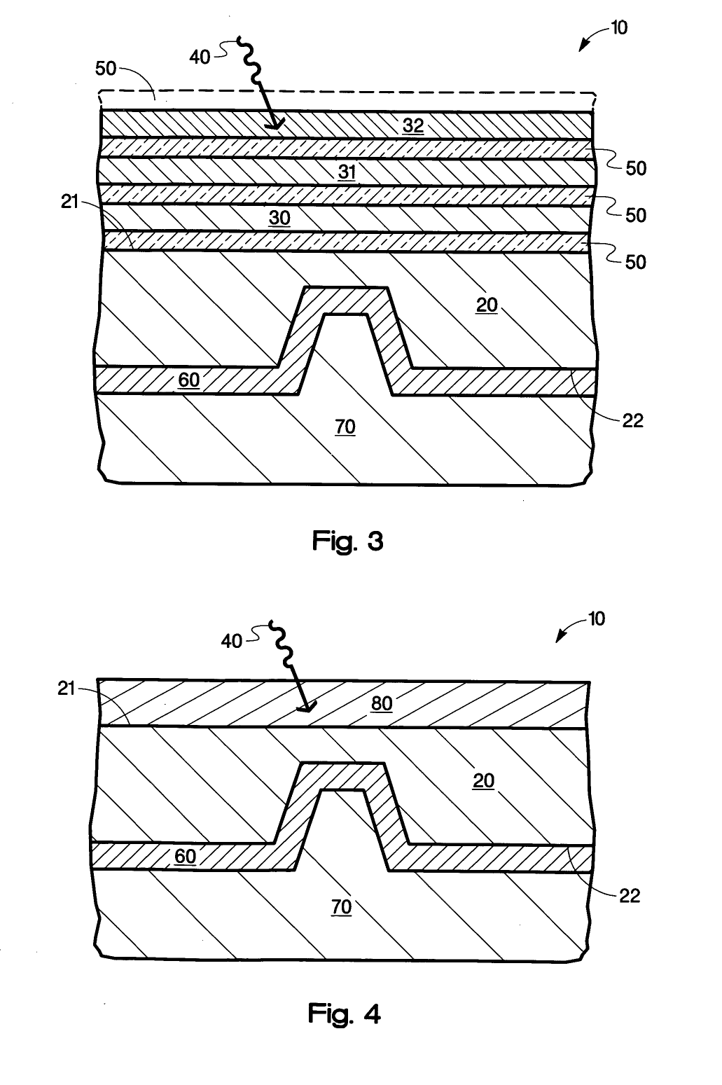

FIG. 3 shows a cross-sectional elevation view of a second embodiment of an image-recording medium. Laser radiation 40 is again shown schematically in FIG. 3. FIG. 3 has three laser-writable layers 30, 31, and 32, separated from substrate 20 and from each other by thermally insulating layers 50. Each adjacent pair of writable layers in FIG. 3 has a separating thermally insulating layer 50 disposed between them. Although the schematic arrow representing laser radiation 40 is shown as ending in layer 32, the laser radiation may penetrate all the writable layers and thermally insulating layers 50. An optional fourth thermally insulating layer 50, shown dashed in FIG. 3, may cover and protect the top writable layer 32.

In some embodiments, such as those illustrated in FIGS. 2 and 3, each of the writable layers 30 is distinct from each of the thermally insulating layers 50. Each of the one or more writable layers 30 may be contiguous with one or more thermally insulating layers 50. If there are two writable layers 30, a thermally insulating layer 50 may be disposed between the writable layers. If there are a larger number of writable layers 30, each pair of writable layers may have a separating thermally insulating layer 50 disposed between them. Each separating thermally insulating layer 50 may be effective as a diffusion barrier, preventing diffusion of chemical species between the pair of writable layers 30 that it separates.

Generally, each of the thermally insulating layers 50 has a first refractive index, and each of the writable layers 30 has a second refractive index. For certain embodiments, these first and second refractive indices may substantially match each other within a predetermined tolerance.

In other embodiments, such as the embodiment illustrated in FIG. 4, a writable material is combined with a thermally insulating material, thereby forming a composite layer 80 adapted to be written by laser radiation 40 to form an image in the composite layer 80. When such a composite layer 80 is formed, its composite refractive index may substantially match the refractive index of any adjacent layer of the image-recording medium 10.

As shown in the drawings, a thermally insulating layer 50 may be disposed and adapted to protect the writable layer 30. For example, the thermally insulating layer 50 may be adapted to substantially prevent ablation and outgassing of material from the writable layer 30 during the imaging. A thermally insulating layer 50 may be hydrophilic, helping to protect writable layer 30 from contaminating substances (e.g., plasticizers). Such a thermally insulating layer 50 may be used over composite layer 80 of FIG. 4, for example, as shown in the embodiment of FIG. 3.

Writable layers 30 may comprise any of a number of materials adapted to be imaged by laser radiation. For example, writable layers 30 may comprise two phases, a polymer matrix first phase with acidic developer dissolved in it, and a leuco-dye second phase, which is not soluble or has low solubility in the first phase at ambient temperature. A visible color is developed through heating of the coating with laser radiation 40. In order to tune the coating to the laser wavelength and provide maximum heating efficiency, such a writable layer may contain a so-called “antenna dye” or “antenna.” In such embodiments, the peak wavelength of the antenna-dye's absorption spectrum corresponds to the laser emission wavelength and provides optimized heating efficiency.

The second phase acts as a color-former (further referred to as a “leuco-phase”). The leuco-phase may be present in the form of small particles dispersed uniformly in the writable layer 30. This leuco-phase may comprise a leuco-dye or an alloy of leuco-dye with a melting aid (i.e., an additive forming a lower-melting eutectic with the leuco-dye).

The first phase mentioned above may comprise a radiation-curable polymer with an acidic developer (e.g., a phenolic material) uniformly dissolved in it. This first phase provides a continuous matrix phase, in which the leuco-phase is uniformly distributed. At normal ambient temperatures, the leuco-phase is practically insoluble in the matrix phase. For this reason, the leuco-dye and the acidic developer are maintained in separate phases at ambient temperatures and cannot react to cause color formation. Upon heating with laser radiation, both phases melt and mix with each other. Components of both phases may also diffuse into each other. Mixing of the these phases enables formation of colored species through reaction between the leuco-dye and the acidic developer. One or both of these phases contain species preferentially absorbing imaging laser radiation 40. These species could be dyes or pigments with a wavelength absorption maximum tuned to that of the wavelength λ_{L} of the imaging laser. If desired, the antenna dye may be uniformly distributed or dissolved in the matrix phase, or the antenna dye may be uniformly distributed or dissolved in both the matrix phase and the leuco-dye phase.

At least some of the embodiments described herein are believed to operate in accordance with the following description. However, the invention should not be construed as being limited to the consequences of any particular theory of operation. Upon irradiation, the antenna dye absorbs electromagnetic radiation and locally heats the writable layer 30, causing its components to melt. Visibly color species are generated upon reaction of leuco-dye and developer, facilitated by intermixing of the molten phases. The visibly colored species (e.g., a complex of open lactone ring leuco-dye with developer) are preserved and stabilized through addition to the matrix phase of aromatic species capable of retarding or preventing leuco-dye crystallization from the matrix phase. Image fading in some leuco-dye-based imaged thermochromic materials may very often be related to leuco-dye crystallization from the amorphous melt. For this reason aromatic species capable of forming eutectics with leuco-dye and preventing its crystallization of leuco-dye from the amorphous phase may act as image stabilizers.

Examples of the leuco-dyes suitable for use in embodiments of writable layer 30 include, but are not limited to fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(phydroxyphenyl)-4,5-diphenylimidazoles, phenethylanilines, phthalocyanine precursors (such as those available from Sitaram Chemicals, India), and other known leuco dye compositions.

Experimental testing has shown that fluoran based dyes are one class of leuco dyes which exhibit particularly desirable properties. Several non-limiting examples of suitable fluoran based leuco dyes include 3-diethylamino-6-methyl-7-anilinofluorane, 3-(N-ethyl-p-toluidino)-6-methyl-7-anilinofluorane, 3-(N-ethyl-Nisoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(Ncyclohexyl-N-methylamino)-6-methyl-7-anilinofluorane, 3-diethylamino-7-(mtrifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(ochloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], 2-anilino-3-methyl-6-(N-ethyl-N-isoamylamino)fluorane (S-205, available from Nagase Co., Ltd), and mixtures thereof. Substances suitable for use in embodiments of writable layer 30 also include aminotriarylmethane leuco dyes such as tris(N,N-dimethylaminophenyl) methane (LCV); tris(N,N-diethylaminophenyl) methane(LECV); tris(N,N-di-n-propylaminophenyl) methane (LPCV); tris(N,N-di-n-butylaminophenyl) methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2); tris(4-diethylamino-2-methylphenyl) methane (LV-3); bis(4-diethylamino-2-methylphenyl)(3,4-dimethoxyphenyl) methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl. Other leuco dyes can also be used in connection with the present invention and are known to those skilled in the art. A more detailed discussion of some of these types of leuco dyes may be found in U.S. Pat. Nos. 3,658,543 and 6,251,571, for example. Additional examples and methods of forming such compounds can be found in “Chemistry and Applications of Leuco Dyes” Ramaiha Muthyala, ed., published by Plenum Press, New York and London, 1997 (ISBN: 0-30645459-9).

Examples of the acidic developers which may be utilized in various embodiments include but are not limited to:

a)Bisphenol S (4,4-Dihydroxydiphenyl sulfone), (pKa=7.02); 2,4-Dihydroxydiphenyl Sulfone, (pKa=6.43);

b) Bis(4-hydroxy-3-allylphenyl) sulfone (Trade name—TG-SA) (pKa=7.22);

c) 4-Hydroxyphenyl-4′-isopropoxyphenyl sulfone (Trade name—D8) (pKa=7.30); and

d) Bisphenol A (pKa=9.73) (2,2′-Bis(4-hydroxyphenyl)propane).

Zinc acetate or other water soluble zinc compounds may be used as a developer in place of the developers listed above.

Examples of the antenna (laser-radiation-absorbing dyes) include but are not limited to indocyanine IR-dyes, such as

a) IR-780 iodide, (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9Cl));

b) IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indolium hydroxide, inner salt sodium salt);

c) 3H-Indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with 4-methylbenzenesulfonic acid (1:1) (9CI) (Lambda max=797 nm), CAS No. 193687-61-5, available from FEW Chemicals GMBH of Wolfen, Germany as S0337;

d) 3H-Indolium, 2-[2-[3-[(1,3-dihydro-1,3,3-trimethyl-2H-indol-2-ylidene)ethylidene]-2-[(1-phenyl-1H-tetrazol-5-yl)thio]-1-cyclohexen-1-yl]ethenyl]-1,3,3-trimethyl-, chloride (9Cl). (Lambda max=798 nm), CAS No. 440102-72-7, available from FEW Chemicals GMBH of Wolfen, Germany as S0507;

e) 1H-Benz[e]indolium, 2-[2-[2-chloro-3-[(1,3-dihydro-1,1,3-trimethyl-2H-benz[e]indol-2-ylidene)ethylidene]-1-cyclohexen-1-yl]ethenyl]-1,1,3-trimethyl-, chloride (9Cl) (Lambda max=813 nm), CAS No. 297173-98-9, available from FEW Chemicals GMBH of Wolfen, Germany as S0391;

f) 1H-Benz[e]indolium, 2-[2-[2-chloro-3-[(1,3-dihydro-1,1,3-trimethyl-2H-benz[e]indol-2-ylidene)ethylidene]-1-cyclohexen-1-yl]ethenyl]-1,1,3-trimethyl-, salt with 4-methylbenzenesulfonic acid (1:1) (9Cl) (Lambda max=813 nm), CAS No. 134127-48-3, available from FEW Chemicals GMBH of Wolfen, Germany as S0094 (also known as Trump Dye or Trump IR);

g) 1H-Benz[e]indolium, 2-[2-[2-chloro-3-[(3-ethyl-1,3-dihydro-1,1-dimethyl-2H-benz[e]indol-2-ylidene)ethylidene]-1-cyclohexen-1-yl]ethenyl]-3-ethyl-1, 1-dimethyl-, salt with 4-methylbenzenesulfonic acid (1:1) (9Cl) (Lambda max=816 nm). CAS No. 460337-33-1, available from FEW Chemicals GMBH of Wolfen, Germany as S0809; and

h) Phthalocyanine or naphthalocyanine IR dyes such as Silicon 2,3-naphthalocyanine bis (trihexylsiloxide) (CAS No. 92396-88-8) (Lambda max=775 nm).

Common commercial applications may require optimization to a development wavelength of about 200 nm to about 900 nm, although wavelengths outside this range may be used by adjusting the radiation antenna and color forming composition accordingly. Suitable radiation antennae may be selected from a number of radiation absorbers such as, but not limited to aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas known to those skilled in the art can also be used in various embodiments.

Each of the thermally insulating layers 50 may comprise a sol-gel material, i.e., a material prepared by a sol-gel technique. Some suitable sol-gel materials and methods are described hereinbelow. The sol-gel material embodiments of thermally insulating layers 50 disclosed herein may include a silicate lattice structurally combined with a long-chain organic polymer. The resulting mixture has pores resulting from dehydration of the silicate lattice and has flexibility. The thermal conductivity of this material can be approximately half of the thermal conductivity of an acrylate lacquer layer, for example, commonly used in image-recording media.

For most embodiments, it is desirable for each of the thermally insulating sol-gel material layers to have a maximum pore size of less than or about 100 nanometers, whereby scattering of visible light by pores is minimized. Methods for measuring pore size are known to those skilled in the art of sol-gel preparation. However, it is not necessary to measure pore size per se, as it is sufficient to determine that light scattering at the appropriate wavelengths is negligible. An unacceptable level of scattering is signaled by a hazy appearance under illumination with visible light.

Embodiments of the thermally insulating layers 50 may comprise a sol-gel material, such as an inorganic oxide matrix formed by a sol-gel process. The inorganic oxide matrix formed by a sol-gel process may comprise silica, a metal oxide, a metal hydroxide, or a combination of these, for example. Furthermore, a thermally insulating layer 50 formed by a sol-gel process may comprise a mixed matrix, including a polymer and an inorganic oxide/hydroxide and/or metal oxide/hydroxide. For such embodiments, the polymer in the mixed matrix may comprise one or more materials such as polyvinyl alcohol (PVA), the other polymers listed below, or combinations thereof. The water-soluble polymer can include, but is not limited to, monomers, oligomers, polymers, and combinations thereof. The water-soluble polymer can include, but is not limited to, a single type of polymer, a mixture of a single type of polymer of differing molecular weights, a mixture of different polymers of various molecular weights, and the like.

The water-soluble polymer can include, but is not limited to, polyvinyl alcohol (PVA), cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelatin, hydroxyethylcellulose, methyl cellulose, polyethyleneimine, polyallylamine, polyvinylamine, dicyanodiamide-polyalkylenepolyamine condensate, polyalkylenepolyamine-dicyandiamideammonium condensate, dicyanodiamide-formalin condensate, an addition polymer of epichlorohydrin-dialkylamine, a polymer of diallyldimethylammoniumchloride (“DADMAC”), a copolymer of diallyldimethylammoniumchloride-SO2, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, and polymers of dimethylaminoethylmethacrylate, a polyvinylalcohol with a pendant quaternary ammonium salt, or combinations thereof. Also, the water-soluble polymer can include, but is not limited to, water-dispersible polymers (e.g., latexes), gelatin, and/or low glass transition temperature (Tg<20° C.) emulsion polymers (e.g., styrene butadiene particles, styrene acrylic particles, vinyl acrylic particles, all-acrylic particles, polyurethane dispersions, and polyester dispersions).

Another aspect of the disclosed embodiments is a method of fabricating an image-recording medium. One embodiment of such a method includes providing a substrate which has two sides, coating the first side with a material adapted for recording of information, and coating the second side with one or more writable layers (adapted to be written by laser radiation to form an image), and with one or more thermally insulating layers comprising a sol-gel material. Such a method is versatile; for example, the writable layer(s) may be distinct from the thermally insulating layers or may be combined and made integral with thermally insulated writable layer(s).

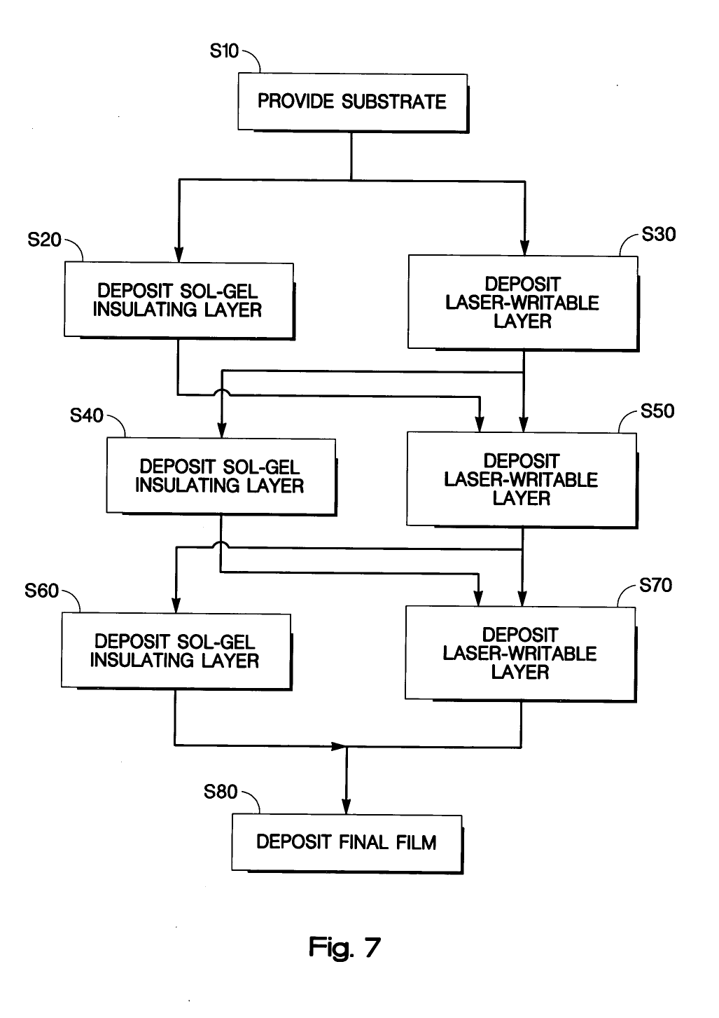

Another aspect of a fabrication method is exemplified by the method embodiment shown in the flowchart of FIG. 7. Various optional paths through the flowchart are indicated by the arrows in FIG. 7. As shown in FIG. 7, a substrate is provided (step S10). The substrate has two sides; the first side is coated with a material adapted for recording of information. To simplify the description, this first side may be called the “data side,” i.e., the side that carries content information, such as computer data, executable program(s), graphic information, sound information, etc. The second side may be called the “label side,” available for label information related to the information on the data side. This description of the two sides is by way of example, and not intended to be limiting. Thus, the content information and the label information may be recorded on the same side(s) of a disk for some applications.

Continuing with the description of the method embodiment of FIG. 7, a sol-gel insulating layer 50 is deposited (step S20), and/or a laser-writable layer 30 is deposited (step S30). As described above, these steps may be combined by depositing a sol-gel insulating layer that also serves as a laser-writable layer 80 as shown in FIG. 4. The combination of steps S20 and S30 provides an initial layer which may be a composite stack of insulating layer 50 with laser-writable layer 30, or an integrated combined layer 80.

As FIG. 7 illustrates, that sub-process may be repeated by performing steps S40 and S50 to provide a second composite or integrated layer, and yet again by performing steps S60 and S70 to provide a third composite or integrated layer. Steps S40 and S60 each include depositing a sol-gel insulating layer 50. Steps S50 and S70 each include depositing a laser-writable layer 30. As in the case of steps S20 and S30, steps S40 and S50 may be combined (i.e., performed simultaneously), and steps S60 and S70 may be combined (i.e., performed simultaneously). The method embodiment depicted in FIG. 7 may be used to make three color layers, for example. However, these sub-processes may be repeated any number of times, not necessarily the three times shown in FIG. 7. Step S80 may be performed to deposit a final film, which may be a protective film, for example. That final film may also be a sol-gel layer 50, a laser-writable layer 30, a composite layer 80, or another layer.

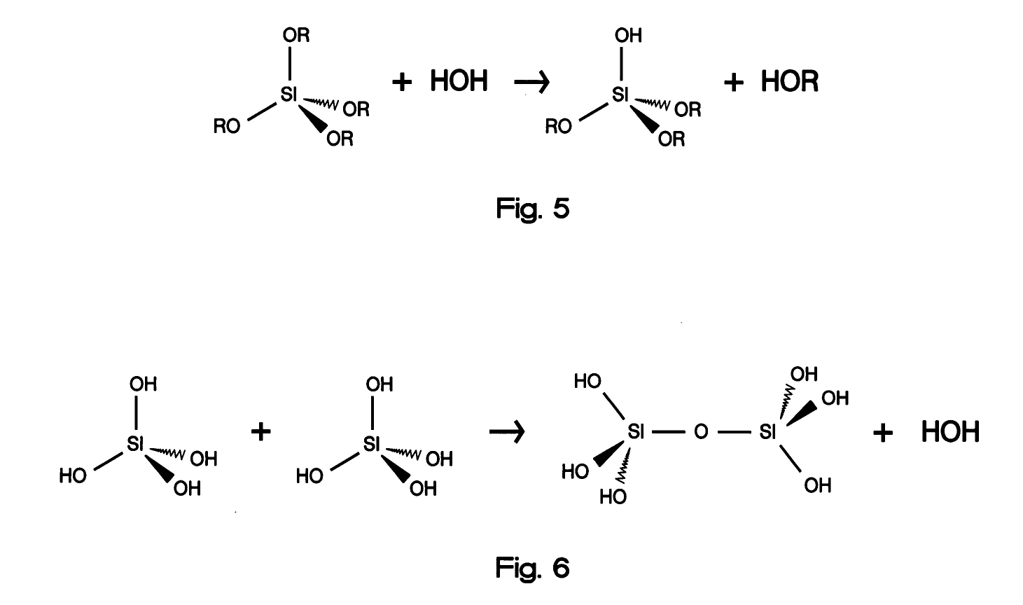

The sol-gel process can be considered in two parts: hydrolysis and condensation. A suitable starting material is a tetra-alkyl orthosilicate that is hydrolyzed (shown in FIG. 5). The condensation reaction proceeds from multiple hydrolyzed silicates to form Si—O—Si (shown in FIG. 6). The reactions can be base- or acid-catalyzed. By changing pH the condensation reaction can be suspended or slowed. The condensation is completed by allowing water evaporation. A sol-polymer composite is made by suspending the sol condensation, by lowering pH of the solution and by mixing the sol with an aqueous solution of polymer such as polyvinyl alcohol (PVA). The mixture is then coated onto a substrate or previous layer, and the water is evaporated. Spin coating is a convenient method to both coat the thermally insulating layer 50 and simultaneously drive off the water. However, other methods such as screen printing may be used.

As described above, each writable layer may itself be formed integrally with the thermally insulating sol-gel material, thus combining the writable and thermally insulating layers into a composite layer. In such embodiments, the polymer matrix first phase with acidic developer dissolved in it and the leuco-dye second phase are uniformly mixed with the inorganic oxide and/or metal hydroxide employed for forming the sol-gel.

Another aspect of the disclosed embodiments is a method of using a thermally insulating layer 50 in an image-recording medium to be labeled by laser radiation to form an image thereon. The laser radiation is characterized by a particular laser wavelength. The thermally insulating layer 50 comprises a material, such as a sol-gel material, substantially transparent both at the laser wavelength and at wavelengths in the visible spectrum. The thermally insulating layer 50 is used either by combining the thermally insulating layer integrally with a writable layer or by disposing the thermally insulating layer contiguous with a distinct writable layer 30.

### EXAMPLES

### Example 1

Tetraethyl orthosilicate (TEOS), ammonium hydroxide, and water (ratio 10/4/60) were mixed at room temperature for three hours. The resultant sol was covered and allowed to further condense at 60° C. overnight (16 hours). The pH of the sol was then adjusted to lower pH. A polyvinyl alcohol (PVA) solution composed of a high-molecular-weight polymer (Air Products, Airvol 540) and a low-molecular-weight polymer (Air Products, Airvol 125) in ratio 3:1. (Airvol 125 and Airvol 540 are hydrolyzed PVA available from Air Products and Chemicals, Inc. of Allentown, Pa.) The resulting PVA solution was mixed with the sol at a ratio of 1:4 dry weights. A color-forming substance was then added to the sol-PVA solution. An aqueous developer (Zinc Acetate) was added to make a concentration of 15%.

An aqueous laser-absorbing dye (FEW S0253, described above) was added to make a concentration of 1%. The raw leuco dye (Noveon Magenta 20, or BK400, milled to 1 micron particle size) was added to make a concentration of 10%.

### Example 2

Preparations as in Example 1 were made with sol pH adjustments to pH 2-8, with similar thermal results for film thicknesses ranging from 0.2-0.5 microns. It was noted that background color could be affected when using the sol-gel as a matrix material for marking.

### Example 3

Preparations as in Example 1 were made with sol-to-PVA ratios adjusted in a range from 4:1 to 1:1, producing results substantially similar to Example 1.

### Example 4

A multi-layer media-label marking structure embodiment was made with a substrate, an acrylate-based marking layer; a sol-gel based thermal layer as in Example 1 (but without a leuco-dye, developer, or laser-absorbing dye); and an acrylate-based marking layer.

### Example 5

A multi-layer media-label marking structure embodiment was made with a substrate, an acrylate based marking layer, a sol-gel marking layer as in Example 1, and an acrylate-based marking layer.

### INDUSTRIAL APPLICABILITY

Devices made in accordance with the invention are useful in image recording media and methods. They may also be used in other laser-imaging applications, such as holography. Image-recording media embodiments made in accordance with the present disclosure have several notable advantages. Thermally insulating layer 50, used between active layers of a color image-recording medium, increases performance. Thermally insulating layer 50, used between two laser-imageable thermochromic layers 30 makes color development in those layers more independent. A sol-gel layer such as thermally insulating layer 50, positioned between two different laser-imageable layers 30 with mutual compatibility issues, may act as a diffusion barrier, preventing migration of chemical species from one layer into another. Even a very thin (1-2 micrometer thickness, for example) thermally insulating layer 50, disposed on a thermochromic laser-imageable layer 30 may significantly reduce or practically eliminate ablation and outgassing of the laser-imageable layer when that layer is imaged. In this way, thermally insulating layer 50 enables higher imaging power densities and enhanced marking contrast. Thermally insulating layer 50 enables laser imaging of an inner layer of multilayer image-recording media at substantially the speed of a top layer. A sol-gel layer such as thermally insulating layer 50 provides ablation prevention and fingerprint protection for single-layer image-recording media. Thus, a sol-gel layer such as thermally insulating layer 50 prevents contamination of laser optics due to ablation-produced debris.

Although the foregoing has been a description and illustration of specific embodiments of the invention, various modifications and changes thereto can be made by persons skilled in the art without departing from the scope and spirit of the invention as defined by the following claims. For example, functionally equivalent materials may be substituted for materials specifically mentioned in this disclosure, and the order of process steps may be varied to some extent. Various layers may be patterned during fabrication if desired, for example to limit label information to a predefined area of a medium.

What is claimed is:

1. An image-recording medium comprising:
a) a substrate;
b) one or more writable layers, adapted to be written by laser radiation characterized by a laser wavelength to form an image therein; and
c) one or more thermally insulating layers comprising a material substantially transparent both at the laser wavelength and at wavelengths in the visible spectrum.

2. The image-recording medium of claim 1, wherein each of the one or more thermally insulating layers comprises a sol-gel material.

3. The image-recording medium of claim 2, wherein each of the one or more thermally insulating layers comprising a sol-gel material has a maximum pore size, the maximum pore size being less than or about 100 nanometers, whereby scattering of visible light thereby is minimized.

4. The image-recording medium of claim 1, wherein the substrate has the form of a compact disk (CD), a digital versatile disk (DVD), or a video disk.

5. The image-recording medium of claim 1, wherein each of the one or more writable layers is distinct from each of the one or more thermally insulating layers.

6. The image-recording medium of claim 1, wherein each of the one or more writable layers is contiguous with one or more thermally insulating layers.

7. The image-recording medium of claim 1, wherein each of the one or more writable layers is combined in one layer with a thermally insulating layer, thereby forming a composite layer adapted to be written by laser radiation to form an image therein.

8. The image-recording medium of claim 1, wherein the substrate has first and second sides, and wherein:
a) the one or more writable layers and the one or more thermally insulating layers are disposed adjacent to the first side of the substrate, and
b) the second side of the substrate is adapted for recording of information thereon.

9. The image-recording medium of claim 1, comprising at least first and second writable layers, wherein a thermally insulating layer is disposed between the first and second writable layers.

10. The image-recording medium of claim 1, comprising a plurality of writable layers, each pair of writable layers having disposed between them a separating thermally insulating layer.

11. The image-recording medium of claim 10, wherein each separating thermally insulating layer is effective as a diffusion barrier, preventing diffusion between the pair of writable layers it separates.

12. The image-recording medium of claim 1, wherein each of the one or more thermally insulating layers is hydrophilic.

13. The image-recording medium of claim 1, wherein each of the one or more thermally insulating layers is disposed and adapted to protect the writable layer.

14. The image-recording medium of claim 1, wherein each of the one or more thermally insulating layers is disposed and adapted to substantially prevent ablation of material from the writable layer.

15. The image-recording medium of claim 1, wherein the each of the one or more thermally insulating layers comprises an inorganic oxide matrix formed by a sol-gel process.

16. The image-recording medium of claim 15, wherein the inorganic oxide matrix formed by a sol-gel process comprises silica, a metal oxide, a metal hydroxide, or a combination thereof.

17. The image-recording medium of claim 1, wherein each of the one or more thermally insulating layers comprises a mixed matrix formed by a sol-gel process, the mixed matrix including a polymer and an inorganic oxide and/or metal hydroxide.

18. The image-recording medium of claim 17, wherein the polymer comprises one or more materials selected from the list consisting of polyvinyl alcohol (PVA), cationic polyvinylalcohol, acetoacetylated polyvinylalcohol, silylated polyvinylalcohol, carboxylated polyvinylalcohol, polyvinylpyrrolidone, copolymer of polyvinylacetate and polyvinylpyrrolidone, copolymer of polyvinylalcohol and polyvinylpyrrolidone, cationic polyvinylpyrrolidone, gelatin, hydroxyethylcellulose, methyl cellulose, polyethyleneimine, polyallylamine, polyvinylamine, dicyandiamide-polyalkylenepolyamine condensate, polyalkylenepolyamine-dicyandiamideammonium condensate, dicyandiamide-formalin condensate, an addition polymer of epichlorohydrin-dialkylamine, a polymer of diallyldimethylammoniumchloride (“DADMAC”), a copolymer of diallyldimethylammoniumchloride-SO2, polyvinylimidazole, polyvinylpyrrolidone, a copolymer of vinylimidazole, polyamidine, chitosan, cationized starch, polymers of vinylbenzyltrimethylqammoniumchloride, (2-methacryloyloxyethyl)trimethyl-ammoniumchloride, polymers of dimethylaminoethylmethacrylate, a polyvinylalcohol with a pendant quaternary ammonium salt, and combinations thereof.

19. The image-recording medium of claim 1, wherein each of the one or more thermally insulating layers has a first refractive index, each of the one or more writable layers has a second refractive index, and the first and second refractive indices substantially match each other within a predetermined tolerance.

20. A method, comprising steps of:
a) providing a substrate having first and second sides,
b) coating the first side with a material adapted for recording of information, and
c) coating the second side with
i) one or more writable layers, adapted to be written by laser radiation to form an image therein; and
ii) one or more thermally insulating layers comprising a sol-gel material.
